(19) United States
(12) Patent Application Publication
(10) Pub. No.: US 2013/0148871 A1
(43) Pub. Date: Jun. 13, 2013

(54) METHOD AND APPARATUS FOR PROCESSING MEDICAL IMAGE

(71) Applicant: Samsung Electronics Co., Ltd., Suwon-si (KR)

(72) Inventors: Jae-hyun Kwon, Hwaseong-si (KR); Sung-su Kim, Yongin-si (KR); Young-hun Sung, Hwaseong-si (KR); Hyun-hwa Oh, Hwaseong-si (KR)

(73) Assignee: Samsung Electronics Co., Ltd., Suwon-si (KR)

(21) Appl. No.: 13/708,734

(22) Filed: Dec. 7, 2012

(30) Foreign Application Priority Data
Dec. 8, 2011 (KR) 10-2011-0131117

(51) Int. Cl. G06K 9/00

(52) U.S. Cl. CPC G06K 9/00
USPC 382/128

(57) ABSTRACT

A method of processing a medical image includes decomposing at least one medical image into multiscale image information having a plurality of directions by transforming the at least one medical image; estimating a variance of coefficients of image information of each scale of the multiscale image information; modifying the multiscale image information having the plurality of directions by modifying values of the coefficients of the image information of each scale using the estimated variance and coefficients of image information of a plurality of scales of the multiscale image information including the scale being modified; and generating a reconstruction image of the at least one medical image by inverse transforming the modified multiscale image information having the plurality of directions.

### CROSS-REFERENCE TO RELATED APPLICATIONS

This application claims the benefit of Korean Patent Application No. 10-2011-0131117 filed on Dec. 8, 2011, in the Korean Intellectual Property Office, the disclosure of which is incorporated herein by reference in its entirety.

### BACKGROUND

1. Field

This disclosure relates to a method and an apparatus for processing a medical image.

2. Description of Related Art

A system for processing a medical image is an apparatus used to obtain an image of a subject and diagnose the existence of a lesion in the subject. For example, a system using x-rays obtains a radiographic image by radiating x-rays to a subject, such as a human body. The system generates a medical image of the subject based on different damping characteristics according to energy bands of the x-rays between tissues forming the subject. The generated medical image includes noise, as well as information formed by the x-rays. Accordingly, in order to provide a high-quality medical image to a doctor or a medical expert, the medical image is processed, for example, to remove the noise and improve details.

### SUMMARY

In one general aspect, a method of processing a medical image may include decomposing at least one medical image into multiscale image information having a plurality of directions by transforming the at least one medical image; estimating a variance of coefficients of image information of each scale of the multiscale image information; modifying the multiscale image information having the plurality of directions by modifying values of the coefficients of the image information of each scale using the estimated variance and coefficients of image information of a plurality of scales of the multiscale image information including the scale being modified; and generating a reconstruction image of the at least one medical image by inverse transforming the modified multiscale image information having the plurality of directions.

The at least one medical image may include medical images of a plurality of energy bands; the decomposing may include decomposing the medical images of the plurality of energy bands into multiscale information having a plurality of directions of each energy band; the estimating may include estimating a variance of coefficients of image information of each scale of the multiscale image information of each energy band; the modifying may include modifying values of the coefficients of the image information of each scale of energy band using the estimated variance of the coefficients of the image information of each scale of each energy band and coefficients of image information of a plurality of scales of the multiscale image information of each energy band including the scale being modified, weighting the modified values of the coefficients of the image information of each scale of each energy band based on the estimated variance, and summing the weighted values of the coefficients of the image information of each scale of each energy band to generate modified multiscale information having a plurality of directions of an entire energy band including the plurality of energy bands; and the generating may include generating a reconstruction image of a medical image of the entire energy band by inverse transforming the modified multiscale image information having the plurality of directions of the entire energy band.

The method may further include calculating a local contrast property of each coefficient of any one medical image of the at least one medical image; and the modifying may include modifying the values of the coefficients of the image information of each scale using the estimated variance and the coefficients of the image information of the plurality of scales of the multiscale image information including the scale being modified and applying the local contrast property of each coefficient of the any one medical image.

The method may further include estimating a variance of coefficients of an entire medical image corresponding to a combination of all of the at least one medical image; and the modifying may include modifying the values of the coefficients of the image information of each scale using the estimated variance of the coefficients of the image information of each scale and the coefficients of the image information of the plurality of scales of the multiscale image information including the scale being modified based on the estimated variance of the coefficients of the entire medical image.

The modifying may include modifying the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a different scale or a different direction than the piece of the image information being modified.

The modifying may include modifying the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a larger scale than the piece of the image information being modified.

The modifying may include modifying the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a smaller scale than the piece of the image information being modified.

The modifying may include modifying the value of the coefficient of each piece of image information of the multiscale image information using the estimated variance of the coefficient of the piece of the image information being modified, the coefficient of the piece of the image information being modified, and the coefficient of a piece of the image information of the multiscale image information having a same scale as the piece of the image information being modified but a different direction than the piece of the image information being modified.

The estimating of the variance may include estimating the variance of the coefficients of the image information of each scale using a median of the coefficients of the image information of each scale.

The estimating of the variance further may include estimating the variance of the coefficients of the image information of each scale using the median of the coefficients of the image information of each scale and values of coefficients adjacent to the coefficients of the image information of each scale.

The decomposing may include decomposing the at least one medical image into multiscale image information having a plurality of frequency band components and a plurality of directions by performing any one transform selected from a wavelet transform, a curvelet transform, a contourlet transform, and a nonsubsampled contourlet transform on the at least one medical image; and the generating may include generating the reconstruction image of the at least one medical image by performing an inverse transform of the any one transform on the modified multiscale image information having the plurality of directions.

In another general aspect, a non-transitory computer-readable storage medium stores a program for controlling a computer to perform the method described above

In another general aspect, an apparatus for processing a medical image includes a medical image decomposer configured to decompose at least one medical image into multiscale image information having a plurality of directions by transforming the at least one medical image; a variance estimator configured to estimate a variance of coefficients of image information of each scale of the multiscale image information; a coefficient modifier configured to modify the multiscale image information having the plurality of directions by modifying values of the coefficients of the image information of each scale using the estimated variance and coefficients of image information of a plurality of scales of the multiscale image information including the scale being modified; and a reconstruction image generator configured to generate a reconstruction image of the at least one medical image by inverse transforming the modified multiscale image information having the plurality of directions.

The at least one medical image may include medical images of a plurality of energy bands; the medical image decomposer may be further configured to decompose the medical images of the plurality of energy bands into multiscale image information having a plurality of directions of each energy band; the variance estimator may be further configured to estimate a variance of coefficients of image information of each scale of the multiscale image information of each energy band; the coefficient modifier may be further configured to modify values of the coefficients of the image information of each scale of each energy band using the estimated variance of the coefficients of the image information of each scale of each energy band and coefficients of image information of a plurality of scales of the multiscale image information of each energy band including the scale being modified, weight the modified values of the coefficients of the image information of each scale of each energy band based on the estimated variance, and sum the weighted values of the coefficients of the image information of each scale of each energy band to generate modified multiscale information having a plurality of directions of an entire energy band including the plurality of energy bands; and the reconstruction image generator may be further configured to generate a reconstruction image of a medical image of the entire energy band by inverse transforming the modified multiscale image information having the plurality of directions of the entire energy band.

The apparatus may further include a local contrast property calculator configured to calculate a local contrast property of each coefficient of any one medical image of the at least one medical image; and the coefficient modifier may be further configured to modify the values of the coefficients of the image information of each scale using the estimated variance and the coefficients of the image information of the plurality of scales of the multiscale image information including the scale being modified and applying the local contrast property of each coefficient of the any one medical image.

The coefficient modifier may be further configured to modify the values of the coefficients of the image information of each scale using the estimated variance, the coefficients of the image information of each scale, and coefficients of image information of the multiscale image information having a larger scale than the scale of the image information being modified.

The variance estimator may be further configured to estimate a variance of an entire medical image corresponding to a combination of all of the at least one medical image; and the coefficient modifier may be further configured to modify the values of the coefficients of the image information of each scale using the estimated variance of the coefficients of the image information of each scale and the coefficients of the image information of the plurality of scales of the multiscale image information including the scale being modified based on the estimated variance of the coefficients of the entire medical image.

The coefficient modifier may be further configured to modify the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a different scale or a different direction than the piece of the image information being modified.

The coefficient modifier may be further configured to modify the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a larger scale than the piece of the image information being modified.

The coefficient modifier may be further configured to modify the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a smaller scale than the piece of the image information being modified.

The coefficient modifier may be further configured to modify the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a same scale as the piece of the image information being modified but a different direction than the piece of the image information being modified.

The variance estimator may be further configured to estimate the variance of the coefficients of the image information of each scale using a median of the coefficients of the image information of each scale.

The variance estimator may be further configured to estimate the variance of the coefficients of the image information of each scale using the median of the coefficients of the image information of each scale and values of coefficients adjacent to the coefficients of the image information of each scale.

The medical image decomposer may be further configured to decompose the at least one medical image into multiscale image information having a plurality of frequency band components and a plurality of directions by performing any one transform selected from a wavelet transform, a curvelet transform, a contourlet transform, and a nonsubsampled contourlet transform on the at least one medical image; and the reconstruction image generator may be further configured to generate the reconstruction image of the at least one medical image by performing an inverse transform of the any one transform on the modified multiscale image information having the plurality of directions.

In another general aspect, a method of processing a medical image includes decomposing a medical image into multiscale image information having a plurality of directions by applying a transform to the medical image; estimating a variance of each of a plurality of coefficients of image information having each direction of each scale of the multiscale image information; modifying a value of each coefficient of the image information having each direction of each scale based on the estimated variance of the coefficient being modified and the value of the coefficient being modified to generate modified multiscale information having a plurality of directions; and generating a reconstruction image of the medical image by applying an inverse of the transform to the modified multiscale information having the plurality of directions.

The modifying may include modifying the value of each coefficient of the image information having each direction of each scale based on the estimated variance of the coefficient being modified, the value of the coefficient being modified, and the value of a coefficient of image information of the multiscale image information having a different direction than the image information being modified, or a different scale than the image information being modified, or both a different direction and a different scale than the image information being modified, to generate the modified multiscale information having the plurality of directions.

The medical image may be a medical image of an entire energy band; the method further may include calculating a local contrast property of each coefficient of a medical image of a partial energy band of the entire energy band; and the modifying may include modifying the value of each coefficient of the image information having each direction of each scale based on the estimated variance of the coefficient being modified, the value of the coefficient being modified, and the local contrast property of a corresponding coefficient of the medical image of the partial energy band.

The decomposing may include decomposing a plurality of medical images of a plurality of energy bands into multiscale image information having a plurality of directions of each energy band by applying a transform to each of the medical images of the plurality of energy bands; the estimating may include estimating a variance of each of a plurality of coefficients of image information having each direction of each scale of the multiscale image information of each energy band; the modifying may include modifying a value of each coefficient of the image information having each direction of each scale of each energy band based on the estimated variance of the coefficient being modified and the value of the coefficient being modified, weighting the modified values of the coefficients of the image information of each scale of each energy band based on the estimated variance, and summing the weighted values of the coefficients of the image information of each scale of each energy band to generate modified multiscale information having a plurality of directions of an entire energy band including the plurality of energy bands; and the generating may include generating a reconstruction image of a medical image of the entire energy band by applying an inverse of the transform applied to the medical images of the plurality of energy bands to the modified multiscale image information having the plurality of directions of the entire energy band.

The decomposing may include decomposing a plurality of medical images of a plurality of energy bands into multiscale image information having a plurality of directions of each energy band by applying a transform to each of the medical images of the plurality of energy bands; the estimating may include estimating a variance of each of a plurality of coefficients of image information having each direction of each scale of the multiscale image information of each energy band, and estimating a variance of each coefficient of a medical image of an entire energy band including the plurality of energy bands; the modifying may include modifying a value of each coefficient of the image information having each direction of each scale of each energy band based on the estimated variance of the coefficient being modified, the value of the coefficient being modified, and the estimated variance of a corresponding coefficient of the medical image of the entire energy band to generate modified multiscale information having a plurality of directions of each energy band; the generating may include generating reconstruction images of the medical images of the plurality of energy bands by applying an inverse of the transform applied to the medical images of the plurality of energy bands to the modified multiscale image information having the plurality of directions of each energy band; and the method further may include generating a medical image of an entire energy band including the plurality of energy bands by calculating a weighted sum of the reconstruction images of the medical images of the plurality of energy bands.

Other features and aspects will be apparent from the following detailed description, the drawings, and the claims.

### BRIEF DESCRIPTION OF THE DRAWINGS

FIG. 1 is a block diagram of an example of a system for processing a medical image.

FIG. 2 is a diagram for describing an example of a radiation generating device of FIG. 1 dividing radiation into a plurality of different energy bands using a source variation method.

FIG. 3 is a graph of an example of a spectrum of an entire energy band detected by a detector.

FIG. 4 is a graph of an example of spectrums of three energy bands detected by a detector.

FIG. 5 is a block diagram of an example of an apparatus for processing a medical image.

FIG. 6 is a diagram for describing an example of decomposing a medical image into multiscale image information having a plurality of directions using a contourlet transform.

FIG. 7 is a diagram for describing an example of decomposing a medical image into multiscale image information having a plurality of directions using a nonsubsampled contourlet transform.

FIG. 8 is a flowchart of an example of a method of processing a medical image.

FIG. 9 is a flowchart of another example of a method of processing a medical image.

FIG. 10 is a flowchart of another example of a method of processing a medical image.

FIG. 11 is a flowchart of another example of a method of processing a medical image.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

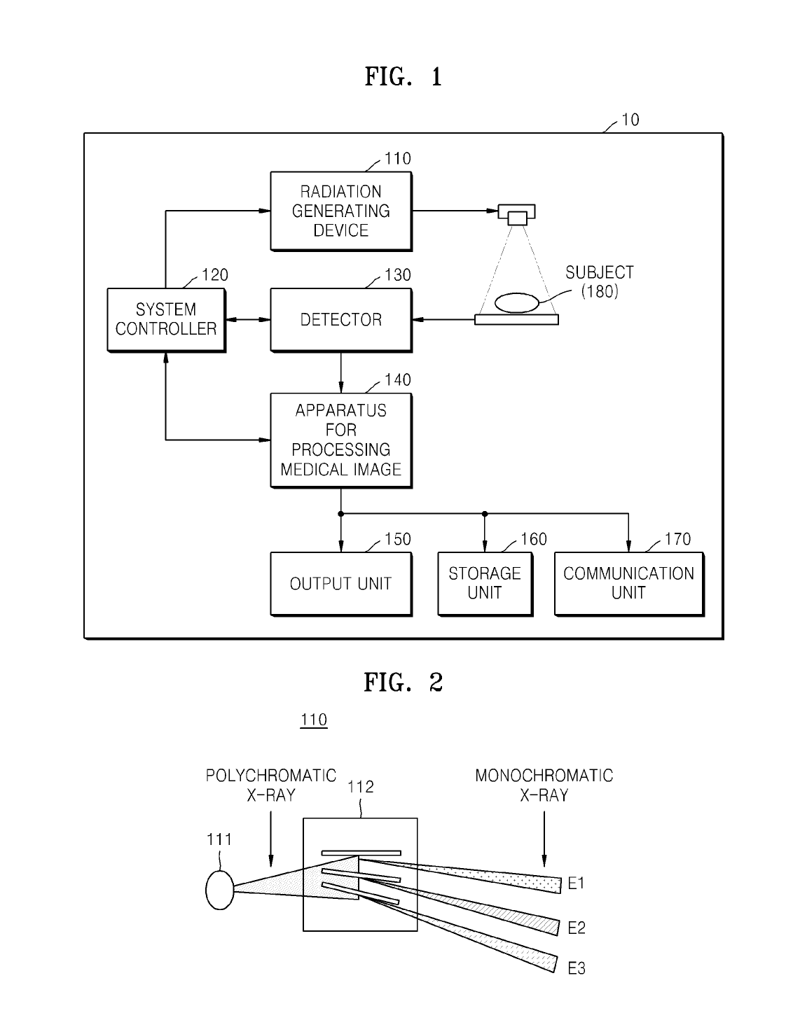

FIG. 1 is a block diagram of an example of a system 10 for processing a medical image. Referring to FIG. 1, the system 10 includes a radiation generating device 110, a system controller 120, a detector 130, an apparatus 140 for processing a medical image, an output unit 150, and a storage unit 160. In FIG. 1, the detector 130 and the apparatus 140 are individual apparatuses, but alternatively, the detector 130 and the apparatus 140 may be integrated into one apparatus.

Only elements related to the current example are shown in the system 10 of FIG. 1, and it will be apparent to one of ordinary skill in the art that other general-purpose elements may also be included in the system 10 of FIG. 1.

Also, the apparatus 140 of FIG. 1 may be implemented by one or more processors. The processor may be implemented by an array of logic gates, or a combination of a general-purpose microprocessor and a memory that stores a program to be executed by the general-purpose microprocessor. Alternatively, the apparatus 140 may be implemented by any other type of hardware device known to one of ordinary skill in the art that is capable of performing the operations performed by the apparatus 140.

The system 10 of this example radiates radiation to a subject 180, detects radiation that passing through the subject 180, and processes a medical image by performing predetermined processing on the detected radiation. The subject 180 may be a breast, a bone, or any other portion of a human body, but is not limited thereto. For example, the system 10 may be a mammography imaging system for detecting a lesion of breast tissues formed only of soft tissues excluding bones.

The radiation generating device 110 generates radiation and radiates the generated radiation to the subject 180. The radiation of this example may be x-rays, but is not limited thereto. For example, the radiation radiated from the radiation generating device 110 to the subject 180 may include both multi-energy x-rays and polychromatic x-rays.

The detector 130 generates a medical image by detecting the radiation passing through the subject 180 from the radiation radiated from the radiation generating device 110 to the subject 180. The detector 130 of this example may include a collimator having through holes to radiate a beam having a predetermined size to the subject 180.

If the radiation, for example, x-rays, radiated to tissues forming the subject 180 has different energy bands, the amount of radiation absorbed by the tissues will be different for each of the energy bands. Therefore, the radiation generating device 110 and the detector 130 of this example may obtain a plurality of medical images by radiating x-rays in at least two different energy bands to the tissues in separate exposures for each of the energy bands, or may obtain a plurality of medical images reflecting different damping characteristics according to energy bands between the tissues by radiating x-rays having at least two different energy bands to the tissues in a single exposure and detecting x-rays passing through the tissues according to the energy bands using an energy discriminator.

The detector 130 of this example may be a detector capable of energy discrimination. For example, the detector 130 of this example may be a photon-counting detector for detecting the radiation passing through the subject 180 according to a plurality of energy bands. The photon-counting detector may include a semiconductor sensor, flip-chip bump bonding connections, and a read-out chip. The read-out chip may include a plurality of single pixel read-out cells. Accordingly, the detector 130 divides an entire energy band of the radiation generated by the radiation generating device 110 into at least two energy bands, detects the radiation according to the energy bands, and generates medical images according to the energy bands from the detected radiation. Alternatively, the detector 130 may generate not only medical images according to at least two different energy bands, but also generate a medical image of the entire energy band of the radiation generated by the radiation generating device 110. Accordingly, the detector 130 may generate a plurality of medical images having different information about the subject 180.

The output unit 150 displays a reconstruction image generated by the apparatus 140. For example, the output unit 150 may be a display panel, a liquid crystal display (LCD) screen, or a monitor of the system 10. Alternatively, the system 10 of this example may not include the output unit 150, but may include a communication unit 170 for outputting the reconstruction image generated by the apparatus 140 to an external display device (not shown).

The storage unit 160 stores data generated during operation of the system 10. The storage unit 160 may be a hard disk drive (HDD), a random-access memory (RAM), a flash memory, a memory card, or any other memory device known to one of ordinary skill in the art capable of storing data generated during operation of the system 10.

The communication unit 170 transmits data to and receives data from an external device through a wired or wireless network, a wired serial connection, or any other type of connection known to one of ordinary skill in the art. Examples of the network include the Internet, a local area network (LAN), a wireless LAN, a wide area network (WAN), a personal area network (PAN), and any other type of network capable of transmitting and receiving data known to one of ordinary skill in the art.

The storage unit 160 and the communication unit 170 of this example may be integrated into a picture archiving and communication system (PACS) that provides image reading and searching functions. Accordingly, the system 10 of this example may display, store, transmit, and receive a reconstruction image from which noise has been removed using multiscale image information having a plurality of directions. Accordingly, a medical expert using the system 10 may easily detect and diagnose a disease, for example, by determining an existence, a size, a location, and other characteristics of a lesion.

FIG. 2 is a diagram for describing an example of the radiation generating device 110 of FIG. 1 dividing radiation into a plurality of different energy bands using a source variation method. Details described above with reference to the radiation generating device 110 of FIG. 1 apply to the radiation generating device 110 of FIG. 2, even though they are omitted in the description of FIG. 2.

The source variation method is a method of obtaining images having different energy bands via continuous multi-exposure by changing or switching a setting of the radiation generating device 110. Alternatively, the source variation method may be performed by dividing a polychromatic x-ray having different energies or wavelengths radiated from a radiation generator 111 of FIG. 2 into monochromatic x-rays having a plurality of different energy bands through a decomposer 112 of FIG. 2.

Referring to FIG. 2, the radiation generating device 110 includes the radiation generator 111 and the decomposer 112. The radiation generator 111 generates the polychromatic x-ray having different energies or wavelengths, and the decomposer 112 decomposes the polychromatic x-ray radiated from the radiation generator 111 into a plurality of monochromatic x-rays E1 through E3 having different energies. In FIG. 2, the polychromatic x-ray is divided into three monochromatic x-rays E1 through E3, but the polychromatic x-ray may be decomposed into monochromatic x-rays having different energy bands. Radiation decomposed according to energy bands and radiated from the radiation generating device 110 are radiated according to energy bands. Thus, the detector 130 detects the radiation according to energy bands.

When the source variation method is used, the radiation generating device 110 radiates radiation having a number of different energy bands equal to a number of decomposed energy bands. Thus, the subject 180 is exposed to radiation a number of times equal to the number of decomposed energy bands. That is, if there are three decomposed energy bands, for example, the subject 180 is exposed to radiation three times, once for each of the three decomposed energy bands.

On the other hand, a detector method that has been described above with reference to FIG. 1 is performed by radiating the radiation having a plurality of energy bands from the radiation generating device 110, and dividing the entire energy band of the radiation passing through the subject 180 into a plurality of energy bands using the detector 130. Accordingly, by using the detector method, medical images in a plurality of energy bands may be obtained by radiating radiation to the subject 180 only once in a single exposure.

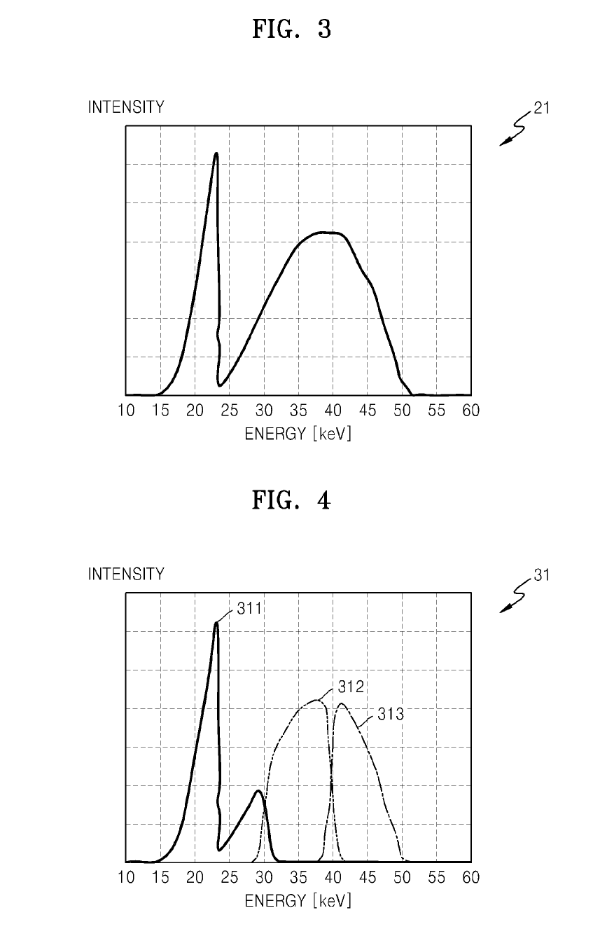

FIG. 3 is a graph 21 of an example of a spectrum of an entire energy band detected by the detector 130 in FIG. 1. Referring to FIG. 3, the graph 21 shows an intensity of the entire energy band of the radiation passing through the subject 180. A horizontal axis of the graph 21 denotes an energy of the radiation, and a vertical axis of the graph 21 denotes an intensity of the radiation. The entire energy band of this example includes all energy bands of the radiation radiated to the subject 180. The detector 130 detects the intensity of the entire energy band of the radiation passing through the subject 180, and generates a medical image of the entire energy band as a single medical image according to the detected intensity. Alternatively, the detector 130 may generate a medical image of the entire energy band by combining medical images according to a plurality of energy bands in the entire energy band.

FIG. 4 is a graph 31 of an example of spectrums of three energy bands detected by the detector 130. The graph 31 shows an intensity of each of the three energy bands of radiation passing through the subject 180. The three energy bands of this example are obtained by dividing the entire energy band of the radiation radiated to the subject 180 into three energy bands. For example, the detector 130 divides the entire energy band into three energy bands, and generates medical images according to the three energy bands.

Referring to FIG. 4, a first spectrum 311 shows an intensity of a first energy band, a second spectrum 312 shows an intensity of a second energy band, and a third spectrum 313 shows an intensity of a third energy band. Accordingly, the detector 130 detects the intensity of the radiation passing through the subject 180 for each of the three energy bands, and generates medical images according to the three energy bands based on the detected intensity. In this case, a medical image generated according to the first spectrum 311 is a medical image of a low energy band. In FIG. 4, the number of energy bands is three, but the number of energy bands is not limited to three, and the detector 130 of this example may divide the entire energy band into any number of energy bands as long as there are at least two energy bands. Also, the detector 130 may suitably determine at least one energy level for dividing the entire energy band into at least two energy bands according to photographing conditions and usage. That is, the detector 130 may determine one energy level to divide the entire energy band into two energy bands, or may determine two energy levels to divide the entire energy band into three energy bands, or may determine three energy levels to divide the entire energy band into four energy bands, and so forth. Accordingly, the detector 130 of this example generates medical images according to a plurality of energy bands, and outputs the generated medical images to the apparatus 140.

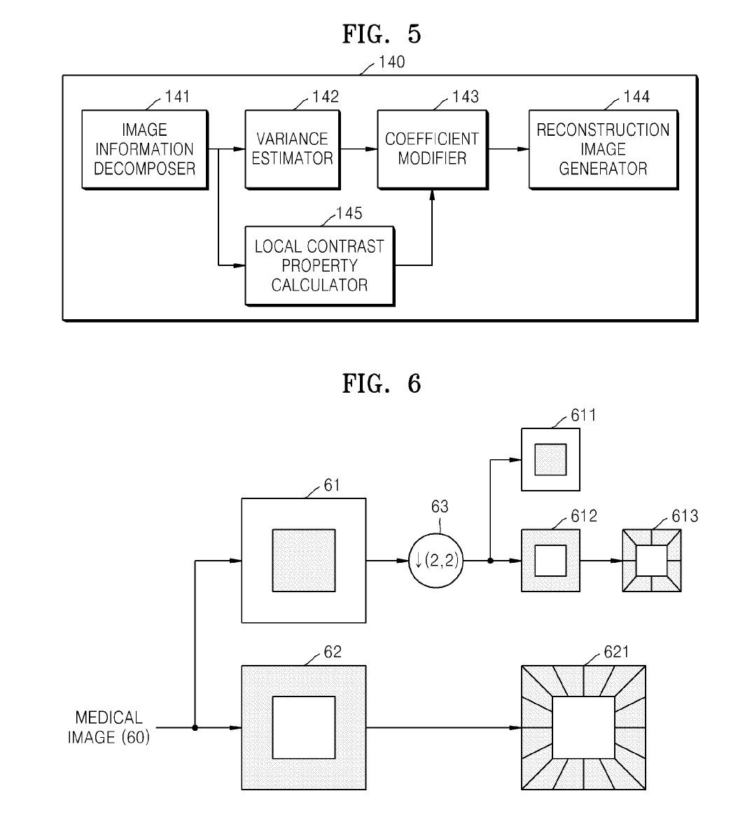

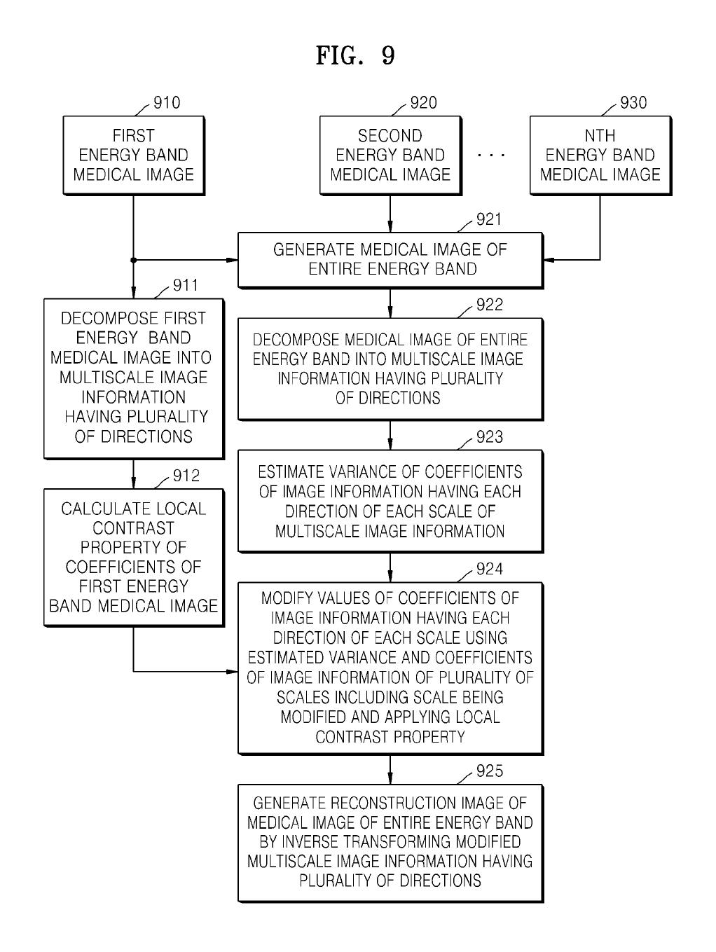

FIG. 5 is a block diagram of an example of the apparatus 140 for processing a medical image. Referring to FIG. 5, the apparatus 140 includes an image information decomposer 141, a variance estimator 142, a coefficient modifier 143, a reconstruction image generator 144, and a local contrast property calculator 145. Only elements related to this example are shown in the apparatus 140 of FIG. 5, and it will be apparent to one of ordinary skill in the art that other general-purpose elements may also be included in the apparatus 140 of FIG. 5. The image information decomposer 141, the variance estimator 142, the coefficient modifier 143, the reconstruction image generator 144, and the local contrast property calculator 145 of FIG. 5 may be implemented by one or more processors. The image information decomposer 141, the variance estimator 142, the coefficient modifier 143, and the reconstruction image generator 144 are described below. The local contrast property calculator 145 will be described later in connection with FIG. 9.

The apparatus 140 in FIG. 5 generates a reconstruction image of a high quality medical image by modifying coefficients of image information of each scale using multiscale image information having a plurality of directions obtained by decomposing a medical image of at least one energy band.

The image information decomposer 141 decomposes at least one medical image input from the detector 130 into multiscale image information having a plurality of directions. At least one medical image may be generated as the detector 130 detects each energy band of radiation passing through the subject 180, or the detector 130 may generate one medical image of an entire energy band. When the detector 130 detects radiation of a plurality of energy bands, a number of medical images equal to a number of energy bands are generated.

A decomposition to multiscale information means that a plurality of decomposing processes are performed by the image information decomposer 141. That is, a decomposition to multiscale information means that the image information decomposer 141 performs a first decomposing process on a medical image input from the detector 130 to generate image information, and generates image information by performing a second decomposing process on the image information generated by the first decomposing process. In other words, a scale is determined by the number of decomposing processes, and image information generated during the same decomposing process is image information of the same scale. In other words, when an initial medical image has a first scale, image information generated by decomposing the image information of the first scale is image information of a second scale, and image information generated by decomposing the image information of the second scale is image information of a third scale. The first scale is a larger or upper scale compared to the second scale, and the second scale is a smaller or lower scale compared to the first scale.

Image information having a plurality of directions may include information about each direction obtained by decomposing information about a plurality of directions of a medical image. In other words, the medical image includes information about a plurality of directions, such as a horizontal direction, a vertical direction, and a diagonal direction, and such information about a plurality of directions may be decomposed to obtain information about each direction. Multiscale image information having a plurality of directions may include information about each direction generated according to a plurality of scales.

The image information decomposer 141 decomposes each medical image of a plurality of partial energy bands received from the detector 130. A partial energy band of radiation is an energy band that is a part of an entire energy band of the radiation. Alternatively, the image information decomposer 141 may decompose a medical image of an entire energy band after generating the medical image of the entire energy band by combining the medical images of the plurality of partial energy bands.

In greater detail, the image information decomposer 141 decomposes a medical image into multiscale image information having a plurality of directions using any one of a wavelet transform, a curvelet transform, a contourlet transform, and a nonsubsampled contourlet transform. In other words, the image information decomposer 141 decomposes the medical image into the multiscale image information having a plurality of directions to obtain image information filtered into a low-frequency band component and a high-frequency band component. A low-frequency band component is image information obtained by reducing a resolution of the medical image, and a high-frequency band component is image information having a certain direction that is generated by extracting direction information from the medical image. The image information decomposer 141 may again decompose the image information in the low-frequency band component, which is obtained by decomposing the medical image, into a low-frequency band component and a high-frequency band component, and multiscale image information having a plurality of directions may be obtained by repeating these decomposing processes.

The variance estimator 142 receives the multiscale image information having a plurality of directions from the image information decomposer 141, and estimates a variance of coefficients of image information of each scale of the multiscale image information. In other words, the multiscale image information decomposed by the image information decomposer 141 includes coefficients, and the variance estimator 142 estimates a variance of the coefficients of the image information. A value of each pixel of image information obtained by transforming a medical image is a coefficient. The variance estimator 142 estimates a variance of coefficients of image information of all scales.

The variance estimator 142 estimates a variance of coefficients of image information having a direction because noise in a medical image mainly appears in a high-frequency band component, and therefore the noise in the medical image may be removed by modifying coefficients of image information of the high-frequency band component to remove the noise. Accordingly, by estimating a variance of coefficients of image information having a direction obtained by decomposing a high-frequency band component, and modifying the coefficients using the estimated variance, noise in a medical image may be removed, thereby improving details of the medical image.

The variance estimator 142 estimates a noise variance σₙ² of coefficients of multiscale image information having a same direction of the multiscale image information having a plurality of directions. The variance estimator 142 estimates the noise variance σₙ² of the coefficients by performing a calculation based on a median of the coefficients. In other words, the variance estimator 142 selects a median of the coefficients of the multiscale image information having the same direction, and estimates the noise variance σₙ² of the coefficients of the multiscale image information having the same direction by performing a calculation based on the median using Equation 1 below.

$${σ}_{n}^{2} = \frac{median ( \vert {y}_{k} \vert )}{NL} \qquad ( 1 )$$

In Equation 1, yₖ denotes coefficients of the multiscale image information having a k direction of a plurality of directions of a scale of the multiscale image information. In other words, an operation of estimating the noise variance σₙ² of the image information having a k direction as shown in Equation 1 is performed for each direction and each scale, thereby estimating noise variances σₙ² of image information of all directions and all scales. A function median( ) is a function for selecting a median of the coefficients inside the parentheses. Accordingly, a median of the coefficients of the image information having a k direction is selected. NL is a predetermined constant, and has a fixed value of 0.6745. According to Equation 1, the variance estimator 142 selects a median of the coefficients of the image information having the same direction of the multiscale image information having a plurality of directions, and obtain the noise variance σₙ² by dividing the median by NL.

The variance estimator 142 estimates a variance σ² of coefficients of image information having a direction using local coefficients of the image information having a direction and the noise variance σₙ². Local coefficients (also known as neighboring coefficients) are coefficients in a predetermined region (also known as a neighborhood) around a particular coefficient of the image information having a direction for which the variance σ² is being estimated. In other words, when the variance estimator 142 estimates the variance σ² of coefficients of the image information having a direction, the variance estimator 142 sequentially estimates the variance σ² for each of the coefficients of the image information having a direction, and coefficients in a predetermined region around the particular coefficient for which the variance σ² is being estimated are the local coefficients. Accordingly, the local coefficients differ depending on the particular coefficient for which the variance σ² is being estimated by the variance estimator 142. The predetermined region may be an N×N region including the particular coefficient for which the variance σ² is being estimated, and the size of the predetermined region may increase or decrease in proportion to a resolution of an input medical image.

Equation 2 is used by the variance estimator 142 to estimate a variance of coefficients of image information of a direction using local coefficients and the noise variance σₙ².

$${σ}^{2} = \vert ( \frac{1}{{NW ( J )}^{2}} {\sum }_{1}^{NW ( J )} {y}_{k , 1}^{2} ) - {σ}_{n}^{2} \vert \qquad ( 2 )$$

In Equation 2, σ² denotes a variance of coefficients of image information having a k direction of a current scale. NW(J) (a neighborhood window) denotes a number of coefficients in the predetermined region that increases or decreases in proportion to a resolution of an input medical image, and the variance estimator 142 may predetermine a range of local coefficients of image information to be used in estimating the variance σ² by modifying the value of NW(J). In other words, NW(J) is a value for determining a predetermined region of image information when local coefficients are used to estimate the variance σ². Also, NW(J) is adjustable according to a noise level based on characteristics of the detector 130. In Equation 2, y_{k,1} denotes a coefficient of image information having a k direction of a current scale (the subscript “1” denotes the current scale). In other words, the variance estimator 142 obtains the variance σ² by calculating the sum of the squares of all of the coefficients in the predetermined region of the image information having a k direction of the current scale determined by the value of NW(J), dividing the sum of the squares by the square of NW(J), and then subtracting the noise variance σₙ² estimated through a median calculation from the result of the dividing. A positive value of the variance σ² is obtained by taking the absolute value of the result of subtracting the noise variance σₙ². The variance σ² is calculated for each coefficient of the image information having a k direction of the current scale.

The coefficient modifier 143 modifies values of coefficients of image information having each direction of each scale of the multiscale image information using the estimated noise variance σₙ², the estimated variances σ² of the coefficients, and the values of the coefficients of the image information. The coefficient modifier 143 uses a bivariate coefficient shrinkage method to modify the values of the coefficients using Equation 3 below.

$${y}_{k , 1}^{′} = \frac{\vert \sqrt{{y}_{k , 1}^{2} + {y}_{k , 2}^{2}} - \frac{t \cdot {σ}_{n}^{2}}{σ} \vert}{\sqrt{{y}_{k , 1}^{2} + {y}_{k , 2}^{2}}} \cdot {y}_{k , 1} \qquad ( 3 )$$

In Equation 3, y_{k,1} denotes a coefficient of image information having a k direction of a current scale (the subscript “1” denotes the current scale), y′_{k,1} denotes a modified coefficient of the image information having the k direction of the current scale, y_{k,2} denotes a coefficient of image information having the k direction of a scale different from the current scale (the subscript “2” denotes the scale different from the current scale), t denotes a constant for adjusting a degree of modification of the coefficient y_{k,1}, σₙ² denotes the noise variance for the k direction of the current scale, and a denotes the square root of the variance σ² of the coefficient y_{k,1}. In other words, y_{k,2} is a coefficient of image information having the same direction k but a different scale. For example, y_{k,2} may be a coefficient of image information having the k direction of an upper or lower scale compared to the current scale.

When the coefficient modifier 143 modifies a coefficient of image information having a direction of each scale, the coefficient modifier 143 may use as the coefficient y_{k,2} a coefficient of image information of an upper scale compared to the scale of the image information of which the coefficient is to be modified, a coefficient of image information of the same scale but having a direction that is different from the direction of the image information of which the coefficient is to be modified, or a coefficient of image information of a lower scale compared to the image information of which the coefficient is to be modified, or a coefficient of image information of a different scale (an upper scale or a lower scale) and having a different direction. Also, when the coefficient modifier 143 modifies a coefficient of image information of the highest scale, the coefficient modifier 143 may use as the coefficient y_{k,2} a coefficient of image information of a low-frequency band component of the highest scale.

Since noise of a medical image is mainly included in a high-frequency band component, the coefficient modifier 143 modifies coefficients of image information of a high-frequency band component, excluding image information of a low-frequency band component, of decomposed image information. In other words, since the image information decomposer 141 decomposes a medical image into a low-frequency band component and a high-frequency band component, and decomposes the high-frequency band component into image information having a plurality of directions, the coefficient modifier 143 modifies coefficients of image information having directions to efficiently remove noise included in the medical image.

The reconstruction image generator 144 generates a reconstruction image of the medical image by performing an inverse transform of the transform performed by the image information decomposer 141 on the multiscale image information having directions having the modified coefficients. In other words, the reconstruction image generator 144 generates a reconstruction image by performing an inverse transform on image information having directions having modified coefficients, and image information of a low-frequency band component that has not been modified. Since the reconstruction image is generated using the multiscale image information having directions having modified coefficients, the generated reconstruction image is the medical image from which noise has been removed.

FIG. 6 is a diagram for describing an example of decomposing a medical image into multiscale image information having a plurality of directions using a contourlet transform. Referring to FIG. 6, the contourlet transform is performed using a double filter structure including a Laplacian pyramid filter bank and a directional filter bank. The contourlet transform and filter structures that perform it are well known to one of ordinary skill in the art, and therefore will not be described in detail here. The image information decomposer 141 decomposes a received medical image 60 using the Laplacian pyramid filter bank into a first low-frequency band component 61 and a first high-frequency band component 62. The first low-frequency band component 61 is an image having a lower resolution than the medical image 60 input to the Laplacian pyramid filter bank. The image information decomposer 141 decomposes the first high-frequency band component 62 into first direction image information 621 having a plurality of directions using the directional filter bank.

The image information decomposer 141 downsamples the first low-frequency band component 61 by 2 vertically and 2 horizontally as indicated by element 63, decomposes the downsampled first low-frequency band component 61 into a second low-frequency band component 611 and a second high-frequency band component 612, and decomposes the second high-frequency band component 612 into second direction image information 613 having a plurality of directions using the directional filter bank by repeating the above decomposing processes. The image information decomposer 141 repeats the decomposing process on the first low-frequency band component 61 generated during the decomposing process to decompose the first low-frequency band component 61 into a multiscale low-frequency band component and multiscale image information having a plurality of directions.

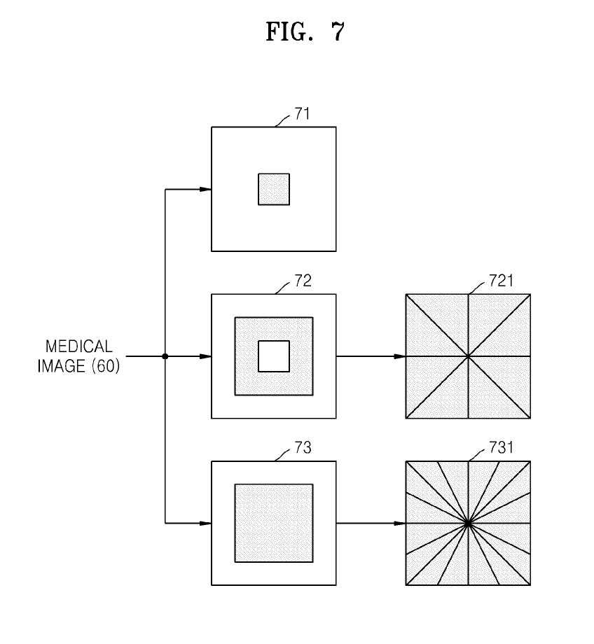

FIG. 7 is a diagram for describing an example of decomposing a medical image into multiscale image information having a plurality of directions using a nonsubsampled contourlet transform. Referring to FIG. 7, the nonsubsampled contourlet transform includes a nonsubsampled pyramid filter bank and a nonsubsampled directional filter bank. The nonsubsampled contourlet transform and filter structures that perform it are well known to one of ordinary skill in the art, and therefore will not be described in detail here. The image information decomposer 141 decomposes the medical image 60 into a first low-frequency band component 71 and first high-frequency band components 72 and 73 using the nonsubsampled pyramid filter bank. The first low-frequency band component 71 is an image having a lower resolution than the medical image 60 input to the nonsubsampled pyramid filter bank. The image information decomposer 141 decomposes the first high-frequency band components 72 and 73 respectively into first direction image information 721 and 731 each having a plurality of directions using the nonsubsampled directional filter bank.

The image information decomposer 141 decomposes the first low-frequency band component 71 into a second low-frequency band component (not shown) and second high-frequency band components (not shown) by repeating the above decomposing process, and decomposes the second high-frequency band components respectively into second direction image information (not shown) each having a plurality of directions using the nonsubsampled directional filter bank. The image information decomposer 141 repeats the decomposing process on the first low-frequency band component 71 generated during the decomposing process to decompose the first low-frequency band component 71 into a multiscale low-frequency band component and multiscale image information having a plurality of directions.

The contourlet transform exhibits shift-variant characteristics due to downsampling and upsampling. However, the nonsubsampled contourlet transform realizes the contourlet transform as an overcomplete transform without a sampling process. Since such a nonsubsampled contourlet transform exhibits shift-invariant characteristics, a ringing artifact, such as a pseudo-Gibbs phenomenon, is not generated around an edge. The ringing artifact is an artifact having a waveform generated at an edge of an image.

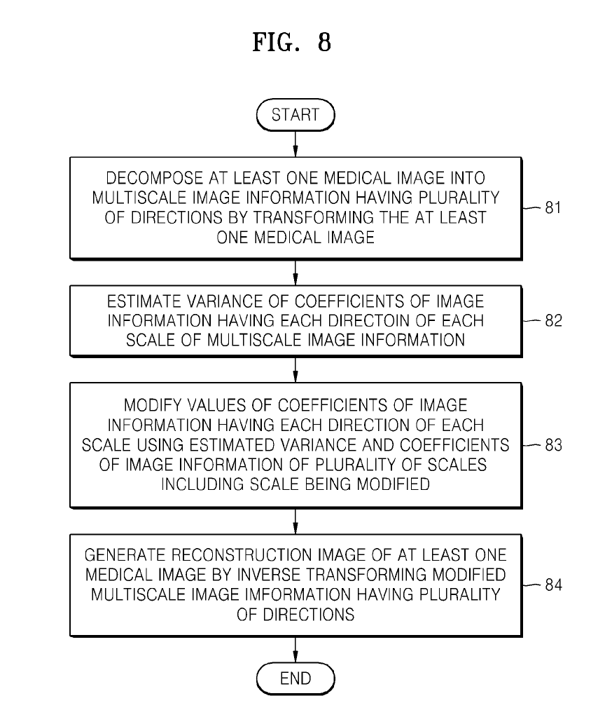

FIG. 8 is a flowchart of an example of a method of processing a medical image. Referring to FIG. 8, the method includes operations performed by the apparatus 140 of FIGS. 1 and 5. Thus, even though omitted below, the description of the apparatus 140 is applicable to the method of FIG. 8. In the method of FIG. 8, the apparatus 140 generates a high-quality reconstruction image by decomposing at least one medical image into multiscale image information having a plurality of directions, and modifying values of coefficients of image information having each direction of each scale of the multiscale image information.

In operation 81, the image information decomposer 141 decomposes at least one medical image received from the detector 130 into multiscale image information having a plurality of directions by transforming the at least one medical image. The image information decomposer 141 may obtain the multiscale image information having a plurality of directions by performing any one of a wavelet transform, a curvelet transform, a contourlet transform, and a nonsubsampled contourlet transform on the at least one medical image received from the detector 130. The multiscale image information is image information obtained as the image information decomposer 141 repeatedly decomposes the medical image, and a scale of the image information indicates how many decomposing processes were performed to obtain the image information. In other words, when a first scale low-frequency band component and a first scale high-frequency band component are generated as the image information decomposer 141 decomposes a medical image into a low-frequency band component and a high-frequency band component, the image information decomposer 141 generates a second scale low-frequency band component and a second scale high-frequency band component by decomposing the first scale low-frequency band component. Since the image information decomposer 141 decomposes the medical image into image information of different scales by repeating such a process, the image information obtained is multiscale image information. Image information having a plurality of directions is image information generated when the image information decomposer 141 extracts directional components of a high-frequency band component. For example, the image information decomposer 141 may generate image information of vertical, horizontal, and diagonal directions by extracting vertical, horizontal, and diagonal components of a high-frequency band component. However, the image information decomposer 141 is not limited to these directions, but may generate image information of any direction by extracting a directional component having any direction of the high-frequency band component.

In operation 82, the variance estimator 142 estimates a variance σ² of coefficients of image information having each direction of each scale of the multiscale image information having a plurality of directions received from the image information decomposer 141 using Equation 2 discussed above. The variance estimator 142 estimates a variance of coefficients of image information having a direction of a scale, and estimates a variance of coefficients of image information having all directions of all scales by repeating the process of estimating the variance of the coefficients of image information having a direction of a scale for all directions and all scales.

Since noise is included in a high-frequency band component in a medical image, the variance estimator 142 estimates a variance of coefficients of image information having a direction. Image information having a direction is a portion of a high-frequency band component in a medical image, and the coefficient modifier 143 modifies coefficients of image information having a direction using the estimated variance as described below, thereby generating modified image information for obtaining an image from which noise has been removed.

In operation 83, the coefficient modifier 143 modifies values of the coefficients of image information having each direction of each scale of the multiscale image information using the estimated variance and coefficients of image information of a plurality of scales including the scale being modified using Equation 3 discussed above. The coefficient modifier 143 receives the estimated variance from the variance estimator 142, and modifies the values of the coefficients of the image information having each direction of each scale using coefficients of image information of an upper scale, a lower scale, or the same scale compared to the image information of the scale being modified. An upper scale of the scale of the image information being modified is a larger scale than the scale of the image information being modified. A scale of image information increases as the number of decomposing processes performed on a medical image to obtain the image information decreases. In other words, the scale of the initial medical image is the largest, highest, or coarsest scale, and the scale of the image information obtained by the last decomposing process that is performed is the smallest, lowest, or finest scale.

The coefficient modifier 143 modifies the values of the coefficients of the image information having a direction of a scale. The coefficient modifier 143 modifies the values of the coefficients of the image information having all directions of all scales by repeating the process of modifying the values of the coefficients of the image information having a direction of a scale for all directions and all scales.

In operation 84, the reconstruction image generator 144 generates a reconstruction image of the medical image of the entire energy band by inverse transforming the modified multiscale image information having a plurality of directions having modified coefficients. The reconstruction image generator 144 receives image information having modified coefficients from the coefficient modifier 143, and generates a reconstruction image of the medical image of the entire energy band by inverse transforming the multiscale image information including the received image information having the modified coefficients. In other words, since the coefficient modifier 143 only modifies coefficients of image information having a direction, the reconstruction image generator 144 generates a reconstruction image using the modified multiscale image information having a plurality of directions having modified coefficients, and a low-frequency band component that has not been modified by the coefficient modifier 143. The reconstruction image is generated using the image information having the modified coefficients, and thus is the medical image from which noise has been removed. The inverse transform performed by the reconstruction image generator 144 is an inverse transform of the transform performed by the image information decomposer 141. For example, if the image information decomposer 141 decomposed the medical image using a nonsubsampled contourlet transform, the reconstruction image generator 144 generates the reconstruction image using an inverse nonsubsampled contourlet transform. The reconstruction image generated by the reconstruction image generator 144 is output to a medical expert through the output unit 150, or the like, and may be stored in the storage unit 160, or the like.

FIG. 9 is a flowchart of another example of a method of processing a medical image. Referring to FIG. 9, the method includes operations performed in sequence by the apparatus 140 of FIGS. 1 and 5. Thus, even though omitted below, the description of the apparatus 140 is applicable to the method of FIG. 9.

In operation 921, the apparatus 140 generates a medical image of an entire energy band by combining first through Nth energy band medical images 910 through 930 received from the detector 130. The first through Nth energy band medical images 910 through 930 are N medical images having different energy bands that are generated from radiation detected in each energy band as the detector 130 detects energy bands of the radiation by dividing an entire energy band of the radiation into N energy bands. Alternatively, the first through Nth energy band medical images 910 through 930 may be medical images that are generated from detected radiation produced by dividing the entire energy band of radiation into N energy bands and separately radiating the radiation of each of the N energy bands to a subject using the radiation generating device 110.

The apparatus 140 may receive the medical image of the entire energy band from the detector 130. In this case, operation 921 is omitted, and the apparatus 140 outputs the medical image of the entire energy band to the image information decomposer 141, and separately receives the first energy band medical image 910 from the detector 130 and outputs the first energy band medical image 910 to the image information decomposer 141.

In operation 922, the image information decomposer 141 decomposes the medical image of the entire energy band into multiscale image information having a plurality of directions.

In operation 923, the variance estimator 142 estimates a variance σ² of coefficients of image information having each direction of each scale of the multiscale image information using Equation 2 discussed above.

In operation 911, the image information decomposer 141 separately decomposes the first energy band medical image 910 into multiscale image information having a plurality of directions and including a low-frequency band component of the first energy band medical image 910. The first energy band medical image 910 is a medical image in the lowest energy band of the energy bands of the radiation.

In operation 912, the local contrast property calculator 145 in FIG. 5 calculates a local contrast property of coefficients of the image information of the first energy band medical image 910. A first energy band is the lowest energy band of the N energy bands of the radiation, and since a contrast property of the first energy band medical image 910 is excellent compared to contrast properties of the second through Nth energy band medical images 920 through 930, which are in higher energy bands than the first energy band medical image 910, the local contrast property calculator 145 calculates the local contrast property of coefficients of the first energy band medical image 910. For example, the apparatus 140 calculates the local contrast property of the coefficients of the first energy band medical image 910 using Equation 4 below.

$${c}_{l} ( x , y ) = \frac{{R}_{l} ( x , y )}{{R}_{l \_ ave} ( x , y )} \qquad ( 4 )$$

In Equation 4, cₗ(x, y) denotes the local contrast property of the coefficient of the first energy band medical image 910 at coordinates (x, y) of the first energy band medical image 910, Rₗ(x, y) denotes image information of the first energy band medical image 910 at coordinates (x, y) of the first energy band medical image 910, and Rₗ_{_{—}}ₐᵥₑ(x, y) denotes image information of a low-frequency band component of the first energy band medical image 910 at coordinates (x, y) of the first energy band medical image 910. In other words, Rₗ_{_{—}}ₐᵥₑ(x, y) denotes image information of the low-frequency band component of the first energy band medical image 910 generated in operation 911.

In operation 924, the coefficient modifier 143 modifies values of coefficients of image information having each direction of each scale of the multiscale image information using the estimated variance and coefficients of image information of a plurality of scales including the scale being modified and applying the local contrast property calculated in operation 912. The apparatus 140 uses Equation 5 below to apply the local contrast property of the first energy band medical image 910 calculated in operation 912 to the medical image of the entire energy band.

R_{f}_{_{—}}ₐₚₚ(x,y)=cₗ(x,y)·R_{f}_{_{—}}ₐᵥₑ(x,y) (5)

In Equation 5, R_{f}_{_{—}}ₐₚₚ (x, y) denotes the medical image of the entire energy band to which the local contrast property has been applied, Rₗ_{_{—}}ₐᵥₑ(x, y) denotes image information of a low-frequency band component of the medical image of the entire energy band, and cₗ(x, y) denotes the local contrast property of the first energy band medical image 910 calculated in operation 912 using Equation 4 above.

In operation 925, the reconstruction image generator 144 generates a reconstruction image of the medical image of the entire energy band by inverse transforming the modified multiscale image information having a plurality of directions.

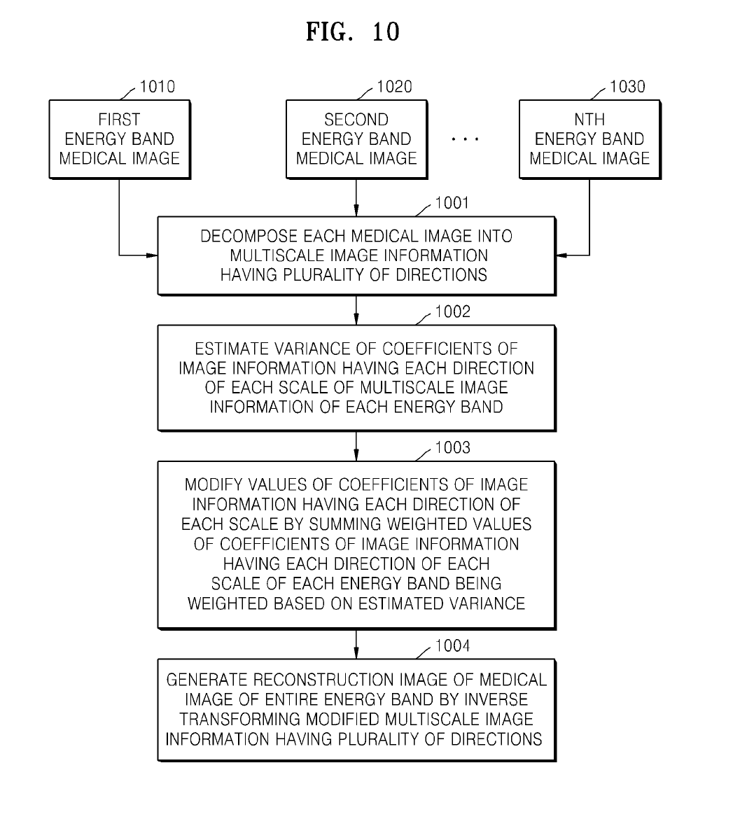

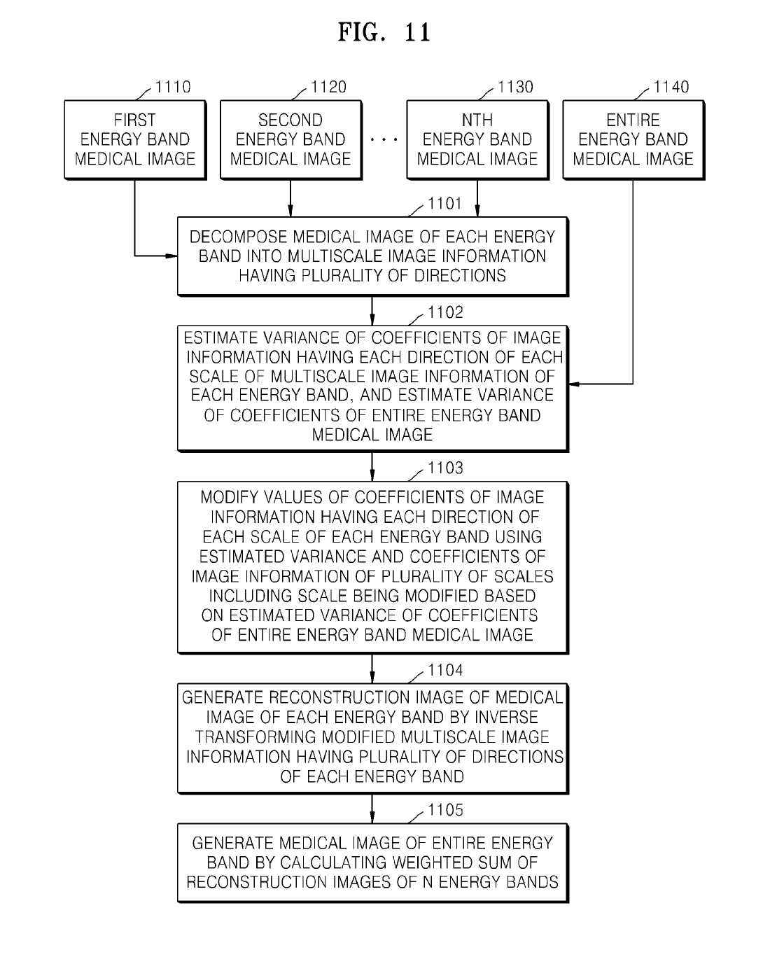

FIG. 10 is a flowchart of another example of a method of processing a medical image. Referring to FIG. 10, the method includes operations performed in sequence by the apparatus 140 of FIGS. 1 and 5. Thus, even though omitted below, the description of the apparatus 140 is applicable to the method of FIG. 10.

In operation 1001, the image information decomposer 141 decomposes each of first through Nth energy band medical images 1010 through 1030 into multiscale image information having a plurality of directions of N energy bands. The first through Nth energy band medical images 1010 through 1030 are N medical images having different energy bands that are generated from radiation detected in each energy band as the detector 130 detects energy bands of the radiation by dividing an entire energy band of the radiation into N energy bands. Alternatively, the first through Nth energy band medical images 1010 through 1030 may be medical images that are generated from detected produced by dividing the entire energy band of radiation into N energy bands and separately radiating the radiation of each of the N energy bands to a subject using the radiation generating device 110.

In operation 1002, the variance estimator 142 estimates a variance σ² of coefficients of image information having each direction of each scale of the multiscale image information of each energy band of the N energy bands using Equation 2 discussed above.

In operation 1003, the coefficient modifier 143 modifies coefficients of image information having each direction of each scale by summing weighted coefficients of image information having each direction of each scale of the multiscale image information of each energy band of the N energy bands, with the weighted coefficients being weighted based on the estimated variance. In greater detail, the image information decomposer 141 decomposes the first through Nth energy band medical images medical 1010 through 1030 to obtain multiscale image information having a plurality of directions including N pieces of image information for each direction k and each scale m, with each of the N pieces corresponding to a different one of the N energy bands. Respective weights depending on the estimated variance σ² are applied to coefficients of the N pieces of image information for each direction k and each scale m, and the weighted coefficients for the N pieces of image information corresponding to the N energy bands are summed to generate one piece of image information having a modified coefficient for each direction k and each scale m of multiscale image information having a plurality of directions for an entire energy band including the N energy bands. For example, the coefficient modifier 143 increases a weight of a coefficient of image information having a relatively low noise as indicated by a relatively low estimated variance σ₂, and decreases a weight of a coefficient of image information having a relatively high noise as indicated by a relatively high estimated variance σ₂.

Equation 6 below is used to modify coefficients of image information of an entire energy band by summing weighted coefficients of image information of a plurality of energy bands.

$${y}_{k , m}^{″} = {\sum }_{i = 1}^{N} {w}_{i} ( {σ}^{2} ) \cdot {y}_{{E}_{i} , k , m}^{′} \qquad ( 6 )$$

In Equation 6, y″_{k,m} denotes a modified coefficient of image information having a k direction of an m-th scale of an entire energy band, N denotes a number of energy bands, y″_{E}_{ᵢ}_{,k,m} denotes a coefficient of image information having a k direction of an m-th scale of an i-th energy band that is obtained for each direction k, each scale m, and each energy band i using Equation 2 described above, and wᵢ(σ²) denotes a weight applied to an i-th energy band that depends on, or is a function of, the estimated variance σ₂. The sum of all the weights is 1.

In operation 1004, the reconstruction image generator 144 generates a reconstruction image of a medical image of an entire energy band by inverse transforming the modified multiscale image information having a plurality of directions produced in operation 1003 using Equation 6 as discussed above. The reconstruction image generator 144 generates the reconstruction image of the medical image of the entire energy band by performing an inverse transform of the transform used by the image information decomposer 141 to decompose each of the first through Nth energy band medical images 1010 through 1030 into multiscale image information having a plurality of directions in operation 1001.

FIG. 11 is a flowchart of another example of a method of processing a medical image. Referring to FIG. 11, the method includes operations performed in sequence by the apparatus 140 of FIGS. 1 and 5. Thus, even though omitted below, the description of the apparatus 140 is applicable to the method of FIG. 11.

In operation 1101, the image information decomposer 141 decomposes each of first through Nth energy band medical images 1110 through 1130 received from the detector 130 into multiscale image information having a plurality of directions of N energy bands.

In operation 1102, the variance estimator 142 estimates a variance of coefficients of image information having each direction of each scale of the multiscale image information of each energy band using Equation 2 discussed above, and a variance of coefficients of an entire energy band medical image 1140 using Equation 2 discussed above, except that the pixel values of the whole energy band medical image 1140 are used as the coefficient y_{k,1} in Equation 2. The entire energy band medical image 1140 has a higher signal-to-noise ratio than the first through Nth energy band medical images 1110 through 1130. Accordingly, the variance estimated from the entire energy band medical image 1140 is referred to while estimating a variance of a medical image in a partial energy band. For example, when a difference between the variance estimated from the entire energy band medical image 1140 and the variance estimated from the medical image of a partial energy band is high, an intensity of a noise reduction process performed on the medical image of the partial energy band is increased. In other words, a difference between a variance estimated from a medical image of an entire energy band and a variance estimated from a medical image of a partial energy band may be obtained to be referred to while estimating the variance of the medical image of the partial energy band.

In operation 1103, the coefficient modifier 143 modifies values of coefficients of image information having each direction of each scale of the multiscale image information of each energy band using the estimated variance and coefficients of image information of a plurality of scales including the scale being modified based on the estimated variance of the coefficients of the entire energy band medical image 1140 using Equation 3 discussed above. The entire energy band medical image 1140 has a higher signal-to-noise ratio than the first through Nth energy band medical images 1110 through 1130. Accordingly, when a difference between the variance estimated from one of the first through Nth energy band medical images 1110 through 1130 and the variance estimated from the entire energy band medical image 1140 is high, an intensity of a noise reduction process performed on the one of the first through Nth energy band medical images 1110 through 1130 by Equation 3 is increased by increasing the constant t in Equation 3. Conversely, when the difference between the variance estimated from the one of the first through Nth energy band medical images 1110 through 1130 and the variance estimated from the entire energy band medical image 1140 is low, an intensity of a noise reduction process performed on the one of the first through Nth energy band medical images 1110 through 1130 by Equation 3 is decreased by decreasing the constant t in Equation 3. In other words, in this example, the constant t in Equation 3 depends on, or is a function of, a difference between the variance estimated from one of the first through Nth energy band medical images 1110 through 1130 and the variance estimated from the entire energy band medical image 1140.

In operation 1104, the reconstruction image generator 144 generates a reconstruction image of the medical image of each of the N energy bands by inverse transforming the modified multiscale image information having a plurality of directions produced in operation 1103 using Equation 3 as discussed above. The reconstruction image generator 144 generates the reconstruction image of the medical image of each of the N energy bands by performing an inverse transform of the transform used by the image information decomposer 141 to decompose each of the first through Nth energy band medical images 1110 through 1130 into multiscale image information having a plurality of directions in operation 1101.

In operation 1105, the apparatus 140 generates a medical image of an entire energy band by calculating a weighted sum of the reconstruction images of the medical images of the N energy bands. The apparatus 140 applies a respective weight to the reconstruction image of the medical image of each energy band generated in operation 1104, with a highest weight being applied to the reconstruction image of the medical image of the energy band having a lowest noise, and a lowest weight being applied to the reconstruction image of the medical image of the energy band having a highest noise. The apparatus 140 generates a medical image by calculating a sum of the weighted reconstruction images, thereby obtaining a medical image of the entire energy band on which a noise reduction process has been performed.

In other words, when the apparatus 140 generates the medical image of the entire energy band by calculating the sum of the weighted reconstruction images, respective weights are applied to the reconstruction images of the medical images of the N energy bands based on an amount of noise included in the reconstruction images. For example, a highest weight may be applied to the reconstruction image of the medical image of the lowest energy band since that reconstruction image includes the lowest noise, and a lowest weight may be applied to the reconstruction image of the medical image of the highest energy band since that reconstruction image includes the highest noise. This weighting causes the medical image of the entire energy band generated by calculating the sum of the weighted reconstruction images of the medical images of the N energy bands to have a reduced signal-to-noise ratio.

As described above, a high-quality medical image can be generated by estimating a variance of coefficients of image information having each direction of each scale of multiscale image information having a plurality of directions, and modifying values of the coefficients of the image information having each direction of each scale using the estimated variance and coefficients of image information of a plurality of scales including the scale being modified. Accordingly, a medical expert can accurately determine an existence, a size, a location, and other characteristics of a lesion in a subject from the high-quality medical image.

The system controller 120, the apparatus 140 for processing a medical image, the image information composer 141, the variance estimator 142, the coefficient modifier 143, the reconstruction image generator 144, and the local contrast property calculator 145 described above may be implemented using one or more hardware components, one or more software components, or a combination of one or more hardware components and one or more software components.

A hardware component may be, for example, a physical device that physically performs one or more operations, but is not limited thereto. Examples of hardware components include amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described therein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of processing a medical image, the method comprising:
decomposing at least one medical image into multiscale image information having a plurality of directions by transforming the at least one medical image;
estimating a variance of coefficients of image information of each scale of the multiscale image information;
modifying the multiscale image information having the plurality of directions by modifying values of the coefficients of the image information of each scale using the estimated variance and coefficients of image information of a plurality of scales of the multiscale image information comprising the scale being modified; and
generating a reconstruction image of the at least one medical image by inverse transforming the modified multiscale image information having the plurality of directions.

2. The method of claim 1, wherein the at least one medical image comprises medical images of a plurality of energy bands;
the decomposing comprises decomposing the medical images of the plurality of energy bands into multiscale information having a plurality of directions of each energy band;
the estimating comprises estimating a variance of coefficients of image information of each scale of the multiscale image information of each energy band;
the modifying comprises:
modifying values of the coefficients of the image information of each scale of energy band using the estimated variance of the coefficients of the image information of each scale of each energy band and coefficients of image information of a plurality of scales of the multiscale image information of each energy band comprising the scale being modified;
weighting the modified values of the coefficients of the image information of each scale of each energy band based on the estimated variance; and
summing the weighted values of the coefficients of the image information of each scale of each energy band to generate modified multiscale information having a plurality of directions of an entire energy band comprising the plurality of energy bands; and
the generating comprises generating a reconstruction image of a medical image of the entire energy band by inverse transforming the modified multiscale image information having the plurality of directions of the entire energy band.

3. The method of claim 1, further comprising calculating a local contrast property of each coefficient of any one medical image of the at least one medical image;
wherein the modifying comprises modifying the values of the coefficients of the image information of each scale using the estimated variance and the coefficients of the image information of the plurality of scales of the multiscale image information comprising the scale being modified and applying the local contrast property of each coefficient of the any one medical image.

4. The method of claim 1, further comprising estimating a variance of coefficients of an entire medical image corresponding to a combination of all of the at least one medical image;
wherein the modifying comprises modifying the values of the coefficients of the image information of each scale using the estimated variance of the coefficients of the image information of each scale and the coefficients of the image information of the plurality of scales of the multiscale image information comprising the scale being modified based on the estimated variance of the coefficients of the entire medical image.

5. The method of claim 1, wherein the modifying comprises modifying the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a different scale or a different direction than the piece of the image information being modified.

6. The method of claim 1, wherein the modifying comprises modifying the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a larger scale than the piece of the image information being modified.

7. The method of claim 1, wherein the modifying comprises modifying the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a smaller scale than the piece of the image information being modified.

8. The method of claim 1, wherein the modifying comprises modifying the value of the coefficient of each piece of image information of the multiscale image information using the estimated variance of the coefficient of the piece of the image information being modified, the coefficient of the piece of the image information being modified, and the coefficient of a piece of the image information of the multiscale image information having a same scale as the piece of the image information being modified but a different direction than the piece of the image information being modified.

9. The method of claim 1, wherein the estimating of the variance comprises estimating the variance of the coefficients of the image information of each scale using a median of the coefficients of the image information of each scale.

10. The method of claim 9, wherein the estimating of the variance further comprises estimating the variance of the coefficients of the image information of each scale using the median of the coefficients of the image information of each scale and values of coefficients adjacent to the coefficients of the image information of each scale.

11. The method of claim 1, wherein the decomposing comprises decomposing the at least one medical image into multiscale image information having a plurality of frequency band components and a plurality of directions by performing any one transform selected from a wavelet transform, a curvelet transform, a contourlet transform, and a nonsubsampled contourlet transform on the at least one medical image; and
the generating comprises generating the reconstruction image of the at least one medical image by performing an inverse transform of the any one transform on the modified multiscale image information having the plurality of directions.

12. A non-transitory computer-readable storage medium storing a program for controlling a computer to perform the method of claim 1.

13. An apparatus for processing a medical image, the apparatus comprising:
a medical image decomposer configured to decompose at least one medical image into multiscale image information having a plurality of directions by transforming the at least one medical image;
a variance estimator configured to estimate a variance of coefficients of image information of each scale of the multiscale image information;
a coefficient modifier configured to modify the multiscale image information having the plurality of directions by modifying values of the coefficients of the image information of each scale using the estimated variance and coefficients of image information of a plurality of scales of the multiscale image information comprising the scale being modified; and
a reconstruction image generator configured to generate a reconstruction image of the at least one medical image by inverse transforming the modified multiscale image information having the plurality of directions.

14. The apparatus of claim 13, wherein the at least one medical image comprises medical images of a plurality of energy bands;
the medical image decomposer is further configured to decompose the medical images of the plurality of energy bands into multiscale image information having a plurality of directions of each energy band;
the variance estimator is further configured to estimate a variance of coefficients of image information of each scale of the multiscale image information of each energy band;
the coefficient modifier is further configured to:
modify values of the coefficients of the image information of each scale of each energy band using the estimated variance of the coefficients of the image information of each scale of each energy band and coefficients of image information of a plurality of scales of the multiscale image information of each energy band comprising the scale being modified;
weight the modified values of the coefficients of the image information of each scale of each energy band based on the estimated variance; and
sum the weighted values of the coefficients of the image information of each scale of each energy band to generate modified multiscale information having a plurality of directions of an entire energy band comprising the plurality of energy bands; and
the reconstruction image generator is further configured to generate a reconstruction image of a medical image of the entire energy band by inverse transforming the modified multiscale image information having the plurality of directions of the entire energy band.

15. The apparatus of claim 13, further comprising a local contrast property calculator configured to calculate a local contrast property of each coefficient of any one medical image of the at least one medical image;
wherein the coefficient modifier is further configured to modify the values of the coefficients of the image information of each scale using the estimated variance and the coefficients of the image information of the plurality of scales of the multiscale image information comprising the scale being modified and applying the local contrast property of each coefficient of the any one medical image.

16. The apparatus of claim 13, wherein the coefficient modifier is further configured to modify the values of the coefficients of the image information of each scale using the estimated variance, the coefficients of the image information of each scale, and coefficients of image information of the multiscale image information having a larger scale than the scale of the image information being modified.

17. The apparatus of claim 13, wherein the variance estimator is further configured to estimate a variance of an entire medical image corresponding to a combination of all of the at least one medical image; and
wherein the coefficient modifier is further configured to modify the values of the coefficients of the image information of each scale using the estimated variance of the coefficients of the image information of each scale and the coefficients of the image information of the plurality of scales of the multiscale image information comprising the scale being modified based on the estimated variance of the coefficients of the entire medical image.

18. The apparatus of claim 13, wherein the coefficient modifier is further configured to modify the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a different scale or a different direction than the piece of the image information being modified.

19. The apparatus of claim 13, wherein the coefficient modifier is further configured to modify the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a larger scale than the piece of the image information being modified.

20. The apparatus of claim 13, wherein the coefficient modifier is further configured to modify the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a smaller scale than the piece of the image information being modified.

21. The apparatus of claim 13, wherein the coefficient modifier is further configured to modify the value of the coefficient of each piece of the image information of the multiscale image information using the estimated variance of the coefficient of the piece of the image information being modified, the coefficient of the piece of the image information being modified, and the coefficient of a piece of the image information of the multiscale image information having a same scale as the piece of the image information being modified but a different direction than the piece of the image information being modified.

22. The apparatus of claim 13, wherein the variance estimator is further configured to estimate the variance of the coefficients of the image information of each scale using a median of the coefficients of the image information of each scale.

23. The apparatus of claim 22, wherein the variance estimator is further configured to estimate the variance of the coefficients of the image information of each scale using the median of the coefficients of the image information of each scale and values of coefficients adjacent to the coefficients of the image information of each scale.

24. The apparatus of claim 13, wherein the medical image decomposer is further configured to decompose the at least one medical image into multiscale image information having a plurality of frequency band components and a plurality of directions by performing any one transform selected from a wavelet transform, a curvelet transform, a contourlet transform, and a nonsubsampled contourlet transform on the at least one medical image; and
the reconstruction image generator is further configured to generate the reconstruction image of the at least one medical image by performing an inverse transform of the any one transform on the modified multiscale image information having the plurality of directions.
